(19) United States
(12) Patent Application Publication
(10) Pub. No.: US 2002/0097977 A1
(43) Pub. Date: Jul. 25, 2002

(54) Variable optical attenuator

(76) Inventors: Masahito Morimoto, Tokyo (JP); Kouki Sato, Tokyo (JP)

Correspondence Address: KNOBBE MARTENS OLSON & BEAR LLP, 620 NEWPORT CENTER DRIVE, SIXTEENTH FLOOR, NEWPORT BEACH, CA, 92660, US

(21) Appl. No.: 10/006,056

(22) Filed: Dec. 6, 2001

(30) Foreign Application Priority Data
Jan. 25, 2001 (JP) 2001-17194

(51) Int. Cl. G02B 6/26

(52) U.S. Cl. 385/140; 385/15

(57) ABSTRACT

An variable optical attenuator according to the present invention has: a first optical fiber for emitting a light beam; a first lens for passing the light beam from the first optical fiber while diffusing the light beam; a second lens for focusing part of the diffused light beam; a second optical fiber for transmitting the focused light beam; and actuator for adjusting the optical path length between the first and second lenses.

### BACKGROUND OF THE INVENTION

1. Field of the Invention

The present invention relates to a variable optical attenuator as one kind of optical modules.

2. Description of the Related Art

In the field of optical communications, a wavelength division multiplex system (WDM) has been developed and put into practical use. In this system, a plurality of multiplexed light beams having wavelengths different from each other propagate through the same transmission channel. In the transmission channel, there are interposed several amplifiers at predetermined intervals. Each amplifier, such as an optical fiber amplifier, amplifies the plurality of light beams in a batch to maintain the predetermined intensity of each of the light beams.

It is desired that the amplified light beams be provided with substantially the same power to prevent the deterioration of transmission quality. However, since the power gain of the optical amplifier has wavelength dependency, the amplified light beams will not have the same power. Accordingly, to provide the light beams with the same power, an optical demultiplexer first separates the amplified light beams according to their respective wavelengths and then a variable optical attenuator corresponding to each of the light beams attenuates each light beam to the predetermined power. Thereafter, attenuated light beams are again multiplexed by means of an optical multiplexer and then allowed to propagate through the transmission channel.

### SUMMARY OF THE INVENTION

A variable optical attenuator according to the present invention comprises a first optical component for emitting a light beam, a first lens for passing the light beam from the first optical component while diffusing the light beam, a second lens for focusing part of the diffused light beam, a second optical component for receiving the focused light beam and transmitting the received light beam, and control means for controlling an optical path length between the first and second lenses.

### BRIEF DESCRIPTION OF THE DRAWINGS

The present invention will become more fully understood from the detailed description given hereinbelow and the accompanying drawings which are given by way of illustration only, and thus, are not limitative of the present invention, and wherein:

FIG. 1 is a perspective view illustrating a variable optical attenuator according to an embodiment of the present invention;

FIG. 2 is a plan view illustrating the attenuator of FIG. 1;

FIG. 3 is an enlarged view of region III of FIG. 2;

FIG. 4 is an enlarged view of region IV of FIG. 2;

FIG. 5 is an enlarged view of region V of FIG. 2;

FIGS. 6 to 12 are explanatory views illustrating the operation of the attenuator of FIG. 1;

FIG. 13 is an explanatory view illustrating the function provided for the attenuator of FIG. 1;

FIG. 14 is a characteristic view illustrating the optical path length dependency of the attenuator of FIG. 1;

FIG. 15 is a characteristic view illustrating the wavelength of the attenuator of FIG. 1; and

FIG. 16 is a characteristic view illustrating the polarization dependency of the attenuator of FIG. 1.

### DETAILED DESCRIPTION

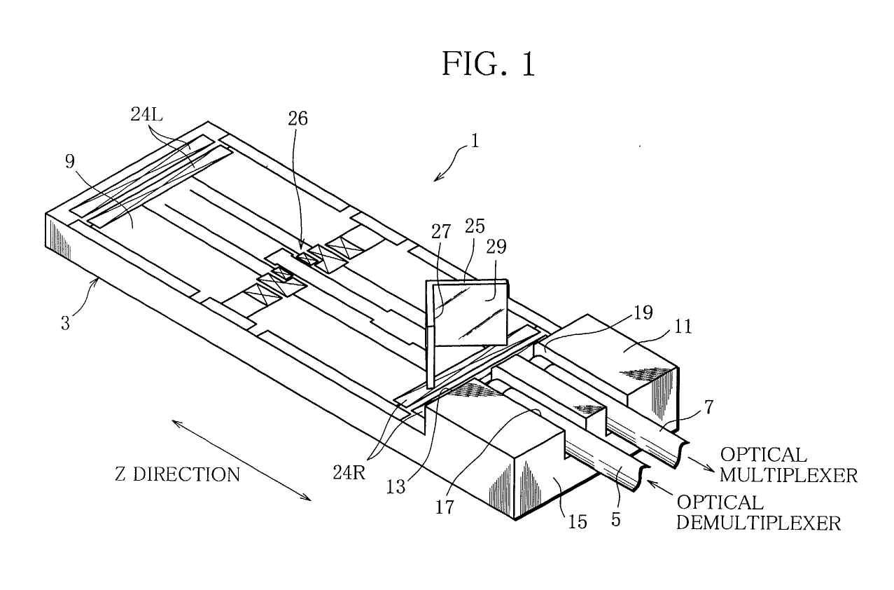

For example, a variable optical attenuator 1 (hereinafter referred to as the VOA 1) of FIG. 1 is interposed in between an optical fiber 5 extending from an optical demultiplexer and an optical fiber 7 connected to an optical multiplexer. The VOA 1 attenuates the power of a light beam received from the optical fiber 5 at a desired attenuation rate and delivers the attenuated light beam to the optical fiber 7.

The VOA 1 comprises a substrate 3 made of Si and the substrate 3 is formed in the shape of a stepped plate. More particularly, the substrate 3 is provided, on an end portion thereof, with a step 11 protruding from an upper surface 9, and the step 11 has end faces 13, 15. Incidentally, a rim is integrally formed on the periphery the upper surface 9 and located below the step 11.

The step 11 is provided with two grooves 17, 19 along the Z direction shown by an arrow in FIG. 1. The grooves 17, 19 are open at the end faces 13, 15, and the bottom surfaces of the grooves 17, 19 are flush with the upper surface 9.

The distal end of the optical fiber 5 is secured to the groove 17. Part of the outer circumference surface of the optical fiber 5 is in contact with the bottom surface of the groove 17. The optical fiber 5 extends outwardly from the end face 15. The proximal end of the optical fiber 7 is secured to the groove 19. Part of the outer circumference surface of the optical fiber 7 is in contact with the bottom surface of the groove 19. The optical fiber 7 extends outwardly from the end face 15.

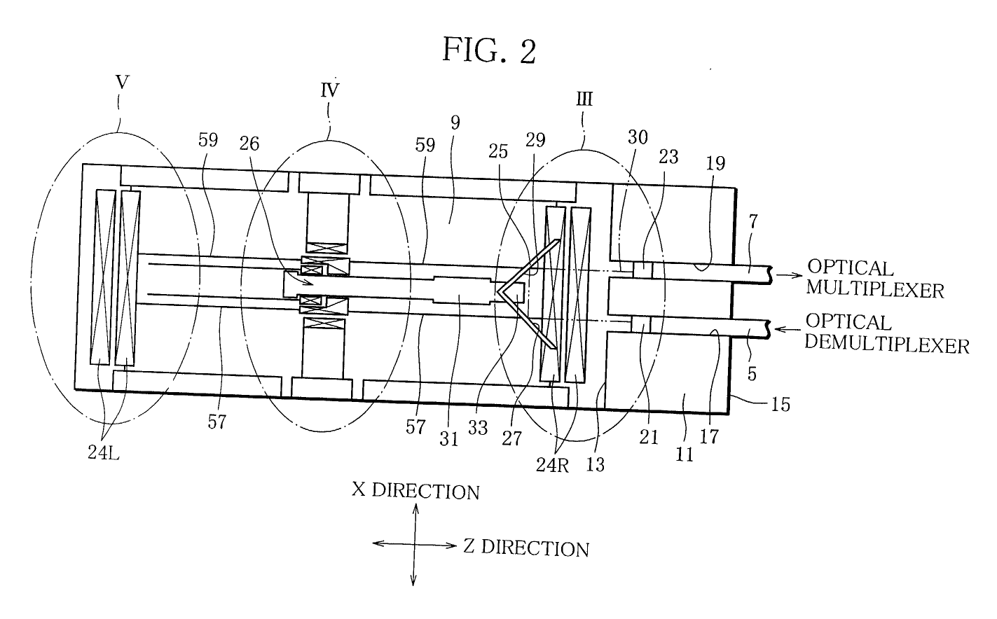

As shown in FIG. 2, rod lenses 21, 23 of graded index fiber are coaxially connected to the distal end of the optical fiber 5 and to the proximal end of the optical fiber 7 by fusion splicing, respectively. The rod lenses 21, 23 are disposed inside the grooves 17, 19, respectively. The optical fibers 5, 7 are equal to each other in outer diameter, and the centers of the rod lenses 21, 23 are approximately at the same height from the upper surface 9.

There are provided an actuator 24R, an actuator 24L, and joint/lock mechanisms 26, which are of use for fixing and/or displacing an optical reflector 25 in the Z direction and will be described later, on the upper surface 9.

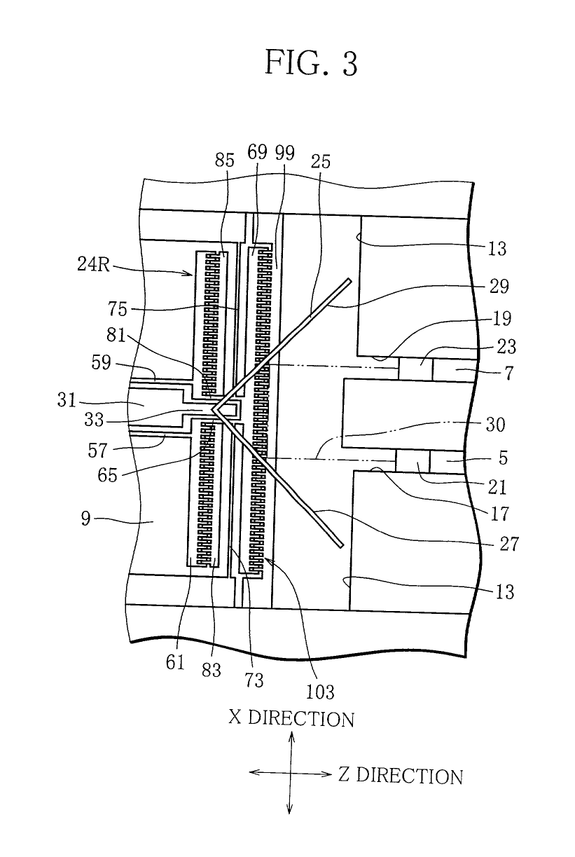

The optical reflector 25 for coupling the rod lens 21 optically to the rod lens 23 is located on the side of the end face 13 of the step 11. As shown in FIG. 3, the reflector 25 has an incidence surface 27 and an outgoing surface 29, which are each inclined at an angle of 45 degrees to the Z direction shown in the figure and orthogonal to each other. An optical axis 30 that connects between the rod lens 21 and the rod lens 23 is indicated with a chain double-dashed line. The optical axis 30 extending from the rod lens 21 is bent into an angle of 90 degrees once at the incidence surface 27 and outgoing surface 29, respectively, and then leads to the rod lens 23.

For example, a block made of Si may be etched to form the aforementioned reflector 25. Further, the incidence surface 27 and the outgoing surface 29 have, for example, a metal film such as Al deposited thereon. Incidentally, for example, a metal plate of Al can also be bent to obtain the reflector 25.

The reflector 25 is secured by means of a thermosetting adhesive to one end portion 33 of a movable stage 31. The movable stage 31 made of Si is formed in the shape of a plate extending in the Z direction and placed on the upper surface 9 movably in the Z direction.

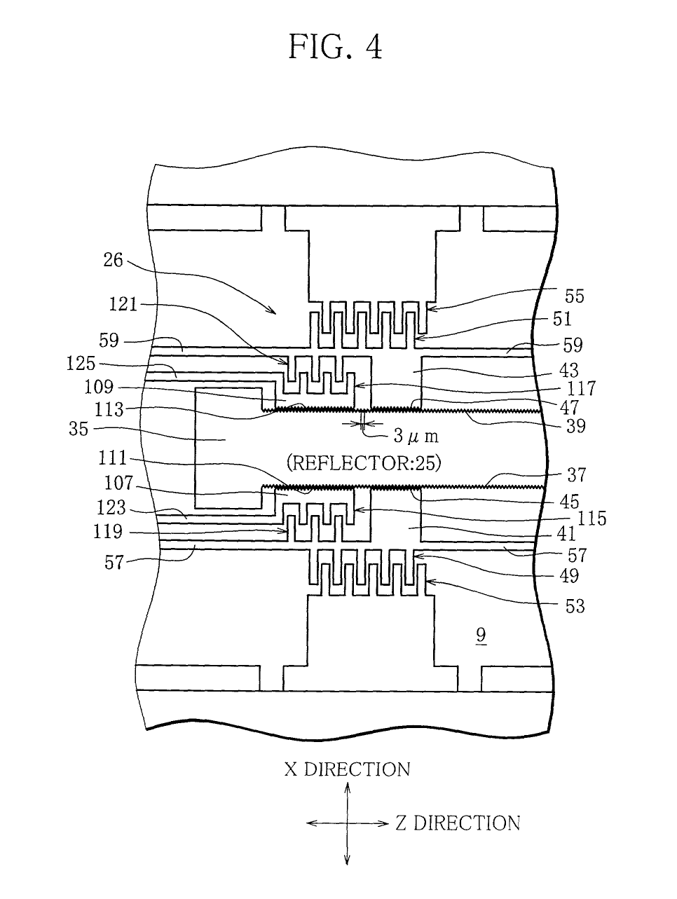

On both sides of the other end portion 35 of the movable stage 31, there are formed rack teeth 37, 39, respectively. The pitch of the rack teeth 37, 39 is 3 μm as shown in FIG. 4. The rack teeth 37, 39 mate each with rack teeth 45, 47, which are formed on joints 41, 43.

The joints 41, 43 are formed of Si and the surfaces thereof are covered with silicone oxide. The joints 41, 43 kept lifted off the upper surface 9. The joints 41, 43 have comb portions 49, 51 formed in one piece therewith opposite to the rack teeth 45, 47. Combs 53, 55 are each disposed to face the comb portions 49, 51 and are formed in one piece with the rim of the upper surface 9.

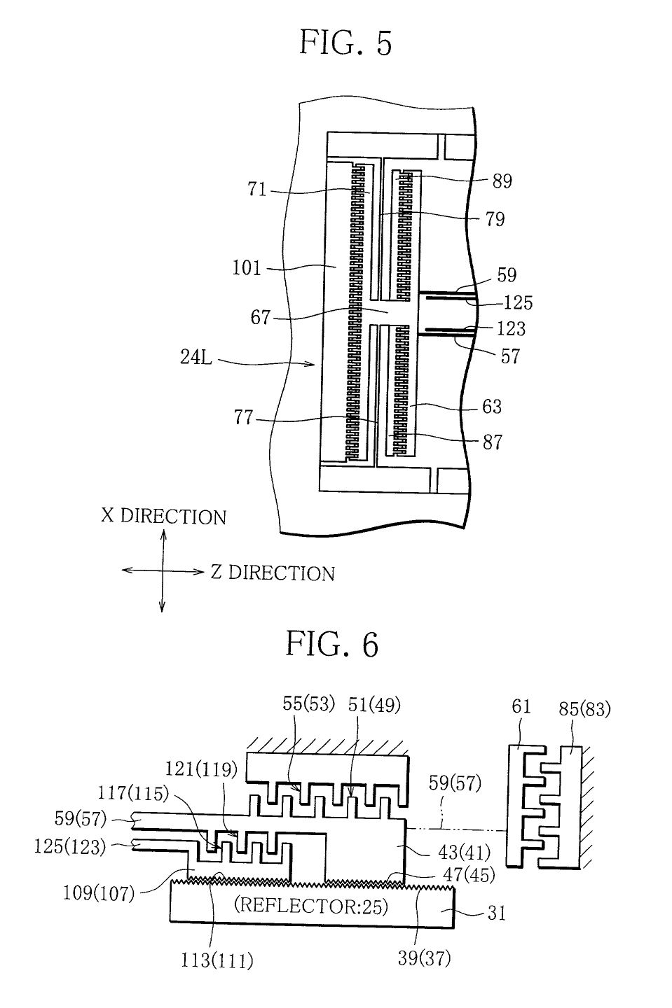

The joints 41, 43 and the comb portions 49, 51 are integrally formed in one piece substantially on the center of longitudinal beams 57, 59 that extend in the Z direction. The longitudinal beams 57, 59 are formed of Si and kept lifted off the upper surface 9. As shown in FIGS. 3 and 5, both the ends of the longitudinal beams 57, 59 are connected to combs 61, 63 extending in the X direction. The longitudinal beams 57, 59 have elasticity and the center thereof is allowed for elastic displacement in the X direction with nodes at their both ends. Therefore, the joints 41, 43 are movable in the X direction.

Bridges 65, 67 extend in the Z direction, opposite to each other, from the center of the teeth side of the combs 61, 63. The bridges 65, 67 are also kept lifted off the upper surface 9. Combs 69, 71, parallel to the combs 61, 63, are secured to ends of the bridges 65, 67, respectively. The aforementioned combs 61, 63, 69, 71 are all formed of Si and kept lifted off the upper surface 9.

When viewed from the Z direction, ends of cross beams 73, 75, 77, 79 are connected to the centers of the bridges 65, 67, respectively. The cross beams 73, 75, 77, 79 extend in the X direction and their proximal ends are integrally connected to the rim of the upper surface 9, respectively. The cross beams 73, 75, 77, 79 have elasticity to make the distal ends thereof displaceable in the Z direction, thereby allowing the bridges 65, 67 to be displaced in the Z direction. Therefore, this also makes the aforementioned combs 61, 63, 69, 71, the longitudinal beams 57, 59 and the joints 41, 43 displaceable in the Z direction via the bridges 65, 67.

The bridge 65 is provided with a notch portion 81, which allows the end portion 33 of the movable stage 31 to move closer to the end face 13 than the comb 61. That is, the notch portion 81 allows the reflector 25 to be brought closer to the end face 13.

Combs 83, 85 and 87, 89 are located near the combs 61 and 63, respectively, to mate therewith. The bridge 65 is interposed between the combs 83 and 85, while the bridge 67 is interposed between the combs 87 and 89. The combs 83, 85, 87, 89 are formed on the upper surface 9. In addition, combs 99, 101 are formed near the combs 69, 71, respectively, to mate therewith. The combs 99, 101 are integrally formed on the rim of the upper surface 9, respectively.

As shown in FIG. 4, locks 107, 109 are located adjacent to both the sides of the end portion 35 of the movable stage 31, respectively. The locks 107, 109 are kept lifted off the upper surface 9 and provided with rack teeth 111, 113 that mate with the rack teeth 37, 39 of the movable stage 31, respectively. There are formed comb portions 115, 117 on the locks 107, 109 opposite to the rack teeth 111, 113. Comb portions 119, 121 are arranged near the comb portions 115, 117 to mate therewith and integrally formed on the longitudinal beams 57, 59.

The locks 107, 109 are provided on distal ends of longitudinal beams 123, 125 formed of Si. Each of the proximal ends of the longitudinal beams 123, 125 is secured to the upper surface 9 so as to be a supporting point. The longitudinal beams 123, 125 have elasticity to allow for displacement of the distal ends thereof in the X direction, thereby making the locks 107, 109 displaceable in the X direction.

The following components, having been described above, can be formed on the substrate 3 through the micro-machining technique comprising well-known processes of dummy-layer deposition and etching and constitute a displacement mechanism for displacing the reflector 25 in the Z direction as described later. That is, the components are the movable stage 31, the joints 41, 43, the longitudinal beams 57, 59, 123, 125, the locks 107, 109, the combs 53, 55, 61, 63, 69, 71, 83, 85, 87, 89, 99, 101, the bridges 65, 67, the cross beams 73, 75, 77, 79, the comb portions 49, 51, 115, 117, 119, 121, and the rack teeth 37, 39, 45, 47, 111, 113. Incidentally, the displacement mechanism formed by the micro-machining technique is a type of a micro-electro-mechanical system (hereinafter referred to as the MEMS).

Now, explained below is the case where the reflector 25 is displaced towards the end face 13 when viewed in the Z direction so that the optical path length between the rod lenses 21 and 23 is made shorter.

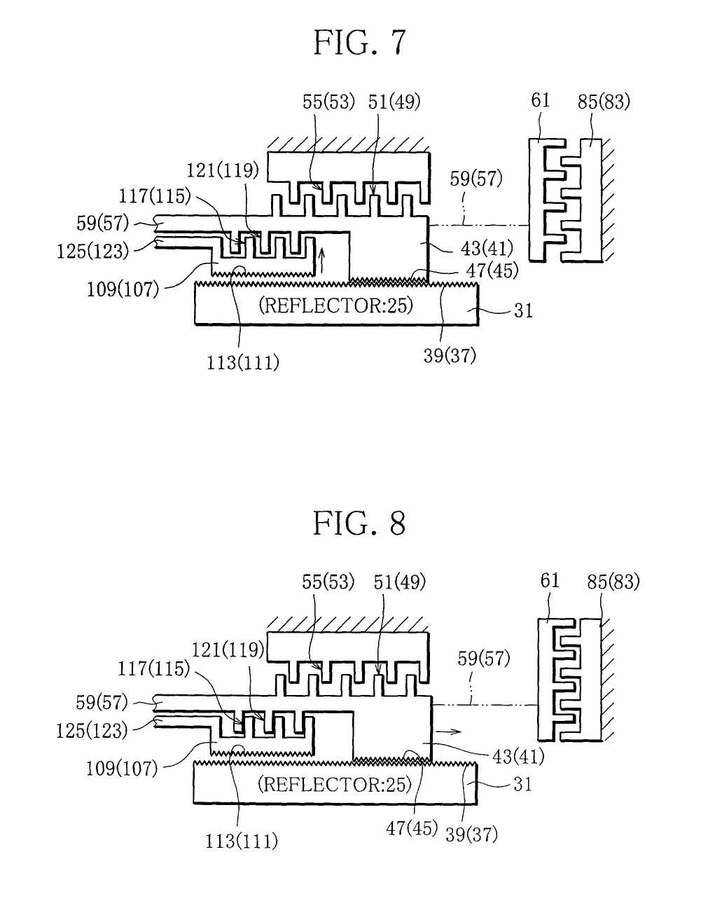

Referring to FIG. 6, the rack teeth 39 (37) engage with the rack teeth 113 (111) of the lock 109 (107), thereby preventing the movable stage 31 from being displaced in the Z direction. The rack teeth 39 (37) of the movable stage 31 also engage with the rack teeth 47 (45) of the joint 43 (41). As shown in FIG. 7, application of a voltage between the lock 109 (107) and the longitudinal beam 59 (57) causes an electrostatic force to act upon the comb portion 117 (115) and the comb portion 121 (119). This in turn causes the lock 109 (107) to be displaced in the X direction towards the longitudinal beam 59 (57) to disengage the rack teeth 113 (111) from the rack teeth 39 (37). As shown in FIG. 8, application of a voltage between the comb 61 and the comb 85 (83) in this condition cause the comb 61 to be displaced towards the comb 85 (83) due to an electrostatic force while the cross beams 73 and 75 are elastically deformed. Therefore, this also causes the movable stage 31 to be displaced towards the comb 85 (83) along with the comb 61, the longitudinal beam 59 (57) and the joint 43 (41). That is, the reflector 25 is displaced towards the end face 13.

As shown in FIG. 9, turning off the voltage between the lock 109 (107) and the longitudinal beam 59 (57) causes the rack teeth 113 (111) of the lock 109 (107) to mate again with the rack teeth 39 (37) of the movable stage 31, so that the lock 109 (107) secures the movable stage 31. Then, as shown in FIG. 10, application of a voltage between the comb portion 51 (49) of the joint 43 (41) and the comb 55 (53) opposite thereto causes the rack teeth 47 (45) of the joint 43 (41) to be disengaged from the rack teeth 39 (37) of the movable stage 31. Then, as shown in FIG. 11, turning off the voltage between the comb 61 and the comb 85 (83) in this condition causes the joint 43 (41) to return to the same position as that shown in FIG. 6 in the Z direction due to the restoring force of the cross beams 73 and 75. Then turning off the voltage between the comb portion 51 (49) and the comb 55 (53) causes the rack teeth 47 (45) of the joint 43 (41) to engage again with the rack teeth 39 (37) of the movable stage 31 as shown in FIG. 12.

As can be seen from FIGS. 6 and 12, the one cycle of the aforementioned operations causes the movable stage 31 or the reflector 25 to be displaced by a pitch of the rack teeth 39 (37), or 3 μm, towards the end face 13 in the Z direction. Incidentally, for simplicity, the operations of the comb portion 69 and the comb 99 have not been explained in the foregoing, however, the comb portion 69 and the comb 99 act in the same manner as the comb 61 and the comb 85 (83), respectively.

Thus it can be said that a pair of the comb 61 and combs 83, 85, a pair of the comb 69 and comb 99, and the bridge 65 constitute the actuator 24R utilizing an electrostatic force for making the optical path length shorter. And it can be also said that a pair of the comb 63 and combs 87, 89, a pair of the comb 71 and comb 101, and the bridge 67 constitute the actuator 24L utilizing an electrostatic force for making the optical path length not shorter but longer. Further, it can be said that the joint/lock mechanisms 26 are constituted by the joints 41, 43, locks 107, 109, and comb 53, 55 utilizing electrostatic forces.

Suppose the reflector 25 is displaced opposite to the end face 13 in the Z direction, the optical path length between the rod lenses 21 and 23 is elongated. This also is performed by the aforementioned cycle of operations except for using the combination of the electrostatic forces between the comb 63 and the combs 87, 89 and between the comb 71 and the comb 101.

As can be seen from FIG. 2, the aforementioned VOA 1 allows a light beam demultiplexed by the optical demultiplexer to be emitted from the rod lens 21 that is secured to the end portion of the optical fiber 5, and then the light beam impinges on the incidence surface 27 of the reflector 25. Subsequently, the light beam is reflected on the incidence surface 27 and the outgoing surface 29 of the reflector 25 to impinge on the rod lens 23 and propagate through the optical fiber 7 to the optical multiplexer.

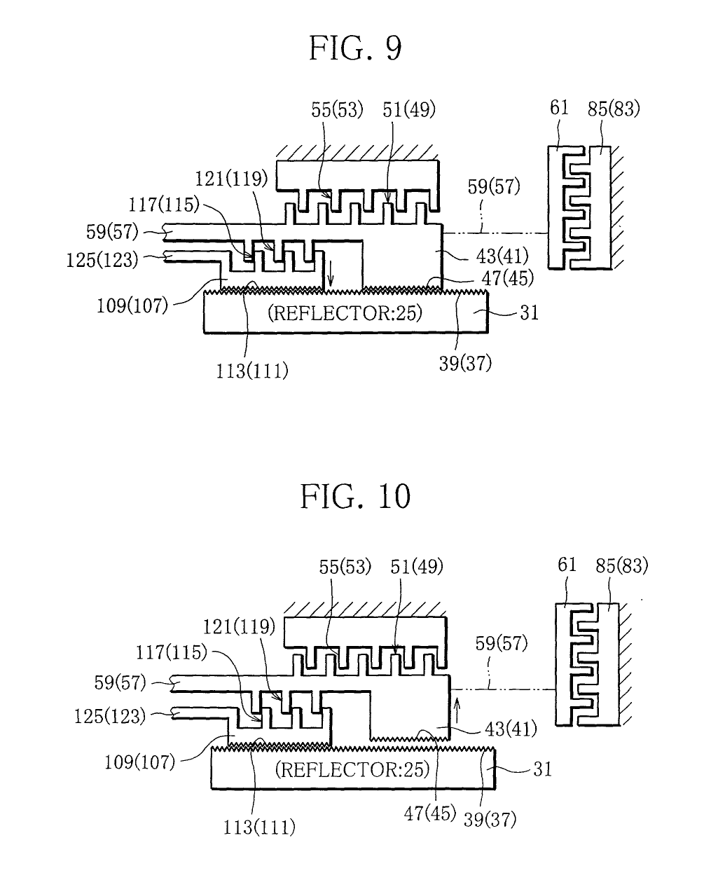

As shown in FIG. 13, the light beam emitted from the rod lens 21 diffused along the optical axis 30 so that the diameter of the light beam gradually increases toward the reflector 25 due to the effect of diffusion of the rod lens 21. Therefore, only a part of the diffused light beam can be incident on the end surface of the rod lens 23 and then is focused with the rod lens 23 to propagate to the optical fiber 7. Accordingly, the power of the light beam propagating through the optical fiber 7 is attenuated compared to the power of the light beam propagating through the optical fiber 5.

Suppose that the reflector 25 is displaced by a length L in the Z direction opposite to the rod lenses 21, 23 or the end face 13 as shown in FIG. 13. This displacement of the reflector makes the distances between the incidence plane 27 and the rod lens 21 and between the outgoing plane 29 and the rod lens 23 longer by the length L, respectively, while the distance between the incidence plane 27 and the outgoing plane 29 is the same. Accordingly, the displacement of the reflector 25 makes the optical length between the rod lenses 21 and 23 longer and the increase of the optical path length being twice times longer than the length L. The increase of the optical path length provides an increased area of incidence for the light beam on a virtual plane including the end surface of the rod lens 23. Consequently, the intensity of the light beam incident on the end surface of the rod lens 23 is reduced, thus causing the optical attenuation to be increased. On the contrary, when the optical path length is made shorter, the area of incidence of the light beam on the virtual plane is decreased and the optical attenuation is thereby reduced. In other words, according to the VOA 1, displacement of the reflector 25 leads to the variation of the optical path length extending between the rod lenses 21 and 23, and thereby results in the adjustment of the optical attenuation.

The aforementioned VOA 1 has no members that absorb the light beam. Light-absorbing members would generate a greater amount of heat as the power of the light beam received increases, leading to damage thereto in some cases. The prior-art variable optical attenuator has a light-absorbing film, which is provided on an optical axis, for absorbing a light beam and thereby attenuating the power of the light beam. In contrast to the prior-art variable optical attenuator, the VOA 1 is applicable to an optical transmission of a larger power.

Furthermore, for example, the VOA 1 is only required to displace the reflector 25 by 1750 μm to provide an optical attenuation of 30 dB. This allows the displacement mechanism for displacing the reflector 25 to be constituted by a type of the aforementioned so-called MEMS. In addition to this, the VOA 1 is provided with a simple optical system comprising lenses and an optical reflector, so that the VOA 1 is small in size.

In contrast to the VOA 1, according to the prior-art VOA provided with the aforementioned light-absorbing film that varies in thickness in one direction, it is possible to adjust the optical attenuation by displacing the light-absorbing film in the aforementioned direction. However, the prior-art VOA is required to displace the light-absorbing film on the order of 1 cm to provide an optical attenuation of 10 dB, for example. Accordingly, in addition to an increase in the maximum thickness of the light-absorbing film, it is necessary to employ a stepping motor or the like to constitute the displacement mechanism for displacing the light-absorbing film. This restricts the miniaturization of the variable optical attenuator.

A prior-art variable optical attenuator that employs a magneto-optical effect requires a complicated optical system comprising a Faraday rotator, a birefringent crystal, a permanent magnet, a polarizer, and an analyzer. This also makes it difficult to reduce the size of the prior-art VOA.

The VOA 1 is provided with an optical system comprising lenses and a reflector whose optical characteristics have low wavelength dependency. Accordingly, the VOA 1 can control the optical attenuation independently with respect to the wavelength of the light beam, thereby making it possible to readily provide the same power for a plurality of light beams having different wavelengths.

In contrast to this, the prior-art variable optical attenuator that employs the magneto-optical effect comprises optical components having a high wavelength dependency and therefore causes the optical attenuation to depend largely on the wavelength. More specifically, suppose that a light beam of wavelength 1565 nm is attenuated by means of the prior-art variable optical attenuator of this type under the condition that an optical attenuation of 30 dB is provided for a light beam of wavelength 1535 nm. In this case, an optical attenuation of approximately 33 dB is provided for the light beam of wavelength 1565 nm. That is, there is a difference by 3 dB in the optical attenuation between the light beams of wavelengths 1535 nm and 1565 nm.

On the other hand, a prior-art shutter-type variable optical attenuator that employs a shutter to control the interruption of the optical path and thereby vary the attenuation of a light beam is described in IEEE Journal of Selected Topics in Quantum Electronics, vol. 5, No. 1, January/February 1999, pp18-25. According to the variable optical attenuator of the shutter type, since the mode field diameter has wavelength dependency, the optical attenuation has a high wavelength dependency. More specifically, suppose that a light beam of wavelength 1600 nm is attenuated by means of the prior-art variable optical attenuator of this type under the condition that an optical attenuation of 12.8 dB is provided for a light beam of wavelength 1530 nm. In this case, an optical attenuation of approximately 12.0 dB is provided for the light beam of wavelength 1600 nm. Likewise, suppose that a light beam of wavelength 1600 nm is attenuated under the condition that an optical attenuation of 13.5 dB is provided for a light beam of wavelength 1530 nm. In this case, an optical attenuation of approximately 12.5 dB is provided for the light beam of wavelength 1600 nm. That is, the wavelength dependency is increased as the optical attenuation is increased.

Therefore, to attenuate a plurality of light beams having different wavelengths by means of these prior-art variable optical attenuators, it is necessary to set the optical attenuation of each variable optical attenuator in connection with the wavelength of the light beam. This makes the control of the attenuator complicated.

On the other hand, the VOA 1 is provided with the optical system comprising lenses and a reflector whose optical characteristics have no dependency on the polarization of the light beam. Therefore, the VOA 1 provides an optical attenuation that has no dependency on polarization. This makes it possible for the VOA 1 to attenuate the light beam independently from the polarization thereof.

In contrast to this, the aforementioned shutter-type variable optical attenuator has a high polarization dependency of optical attenuation. This is because the light beam interrupted by the shutter is diffracted to spread and the spread light beam is incident upon an optical fiber, which has polarization dependency of reflectivity near the circumferential rim of the core thereof. Accordingly, for the shutter-type optical attenuator, it is necessary to set the optical attenuation in connection with the polarization of the light beam. This makes the control complicated and in some cases makes it difficult to provide the light beam with stable power.

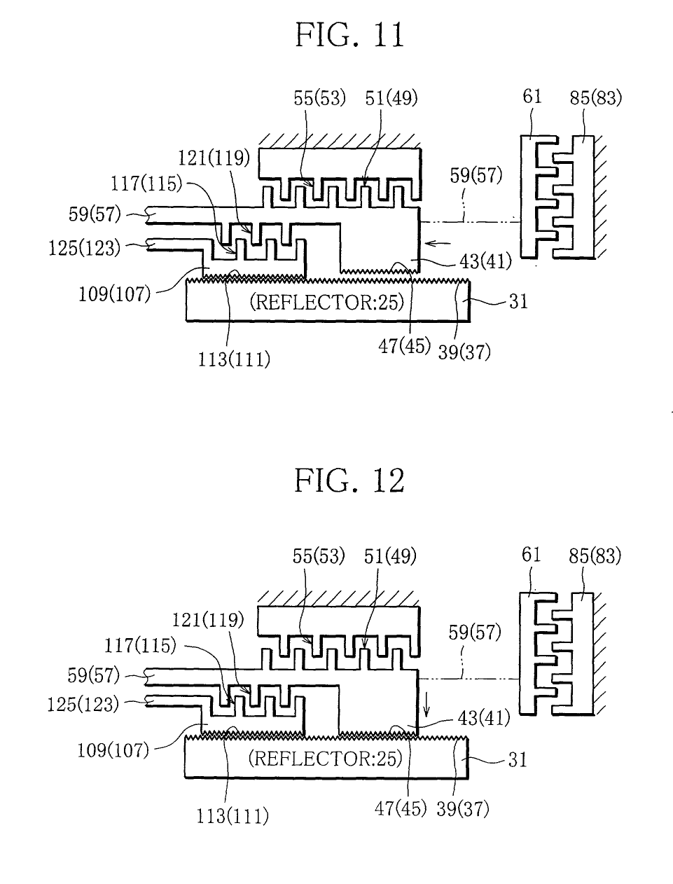

FIG. 14 illustrates the optical path length dependency of the optical attenuation of the VOA 1. That is, FIG. 14 shows the relationship between the length of the optical axis 30 extending between the rod lenses 21 and 23 and the attenuation of the light beam having a wavelength of 1550 μm. For convenience, the abscissa shown in FIG. 14 denotes the increment of the optical path length compared to the shortest optical path length, where the reflector has been brought the closest to the end face 13. More specifically, the abscissa represents variations in optical path length provided when the reflector 25 is displaced opposite to the end face 13 in the Z direction. As can be seen from FIG. 14, the insertion loss of the VOA 1 or the optical attenuation for the shortest optical path length is 0.3 dB while displacement of the reflector 25 opposite to the end face 13 by 1750μm or increasing the optical path length by 3500 μm provides an optical attenuation of 30 dB. The VOA 1 thus can provide the range of optical attenuation from 0.3 dB to 30 dB by varying the optical path length.

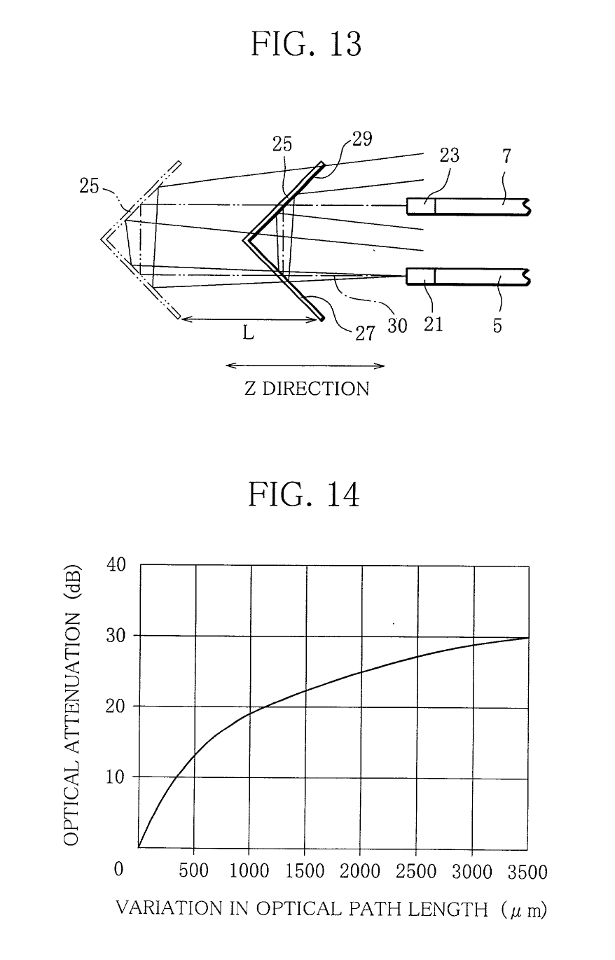

FIG. 15 shows the wavelength dependency of the VOA 1. Solid lines A, B, C indicate the results of measurement of optical attenuations obtained by varying the wavelength of the light beam on the condition that the optical path length between the rod lenses 21 and 23 of VOA 1 is adjusted to provide an optical attenuation of 10 dB, 20 dB, and 30 dB in FIG. 14, respectively. As can be seen from the solid line C in FIG. 15, when the optical path length of the VOA 1 is adjusted to provide an optical attenuation of about 30 dB, the difference in optical attenuation between wavelengths 1530 nm and 1580 nm is as extremely low as 0.36 dB or less. Also as can be seen from the solid lines A, B, the differences in optical attenuation between wavelengths 1530 nm and 1580 nm are 0.18 dB and 0.25 dB at the optical path lengths having the optical attenuation of about 10 dB and 20 dbB, respectively. Thus it can be said from this fact that the optical attenuation of the VOA 1 is independent of wavelength.

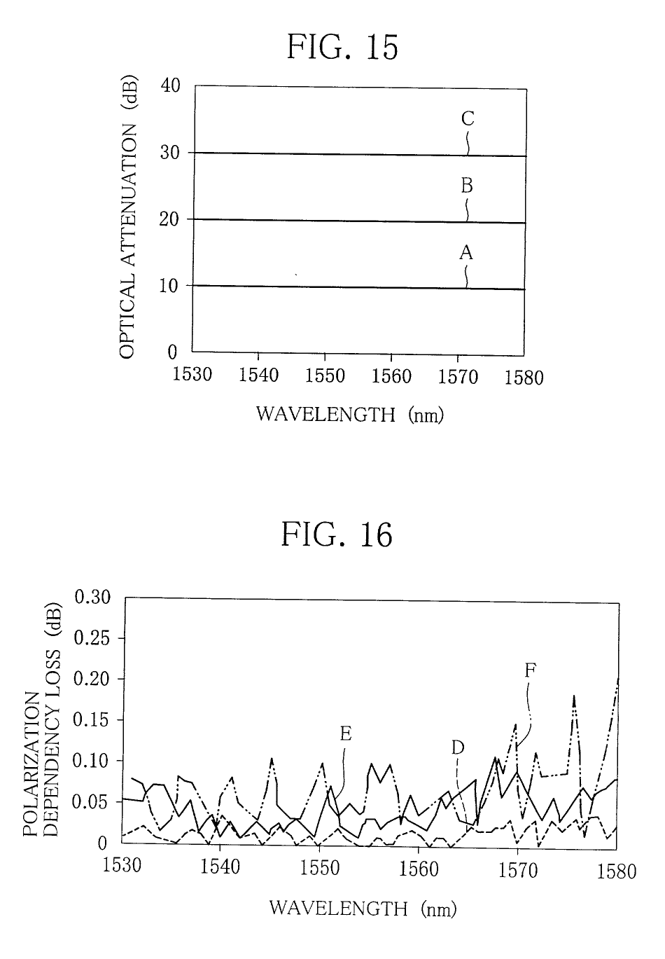

FIG. 16 shows the polarization dependency of optical attenuation of the VOA 1. A Dashed line D, a solid line E, and a chain double-dashed line F indicate the results of measurement of polarization dependency losses obtained by varying the wavelength of the light beam at constant intervals on the condition that the optical path length between the rod lenses 21 and 23 being each adapted to provide an optical attenuation of 10 dB, 20 dB, and 30 dB in FIG. 14, respectively. The polarization dependency loss means the difference in optical attenuation between two light beams having polarization planes orthogonal to each other at each wavelength. As can be seen from FIG. 16, polarization dependency losses are 0.05, 0.1, and 0.21 dB or less within the wavelength range from 1530 to 1580 nm at the optical path lengths having the optical attenuation of about 10 dB, 20 dB and 30 dB, respectively. It can be thus said from this fact that the optical attenuation of the VOA 1 is independent of polarization of the light beam.

Incidentally, the present invention is not limited to the aforementioned embodiment but may be modified in a variety of ways.

For example, in the embodiment, a rod lens of a grated index fiber was employed to diffuse or focus a light beam. However, the present invention is not limited thereto but may employ any lenses so long as the lenses can diffuse or focus a light beam. The lenses may include a spherical lens, an aspherical lens, or a combination of a plurality of lenses.

In the embodiment, the rod lenses and optical fibers were connected to each other by fusion splicing, however, may be disposed spaced apart from each other. Nevertheless, the method for securing the rod lens and the optical fiber connected to each other by fusion splicing to the groove is still preferable since the method facilitates the alignment of the optical axis of the lens with that of the optical fiber.

Furthermore, in the embodiment, the reflector was formed in the shape of a bent plate, however, may be formed in the shape of a block such as a prism which is formed of an optically transparent material and has reflective planes orthogonal to each other.

Furthermore, the actuators employed an electrostatic force, however, may be provided with an electromagnet to use the electromagnetic force thereof. Nevertheless, it is still preferable that the actuator utilizes the electrostatic force since such an actuator can be readily reduced in size.

Still furthermore, in the embodiment, an optical fiber was employed as an optical component for allowing light into the VOA and delivering light from the VOA. However, the optical component is not limited thereto but may be any one such as an optical waveguide so long as the optical component can allow the light beam to propagate therethrough while maintaining the phase and amplitude of the light beam at an appropriate level.

Furthermore, in the embodiment, the variable optical attenuator was interposed in between the optical demultiplexer and optical multiplexer. However, the variable optical attenuator according to the present invention can be incorporated into an optical demultiplexer and/or an optical multiplexer.

What is claimed is:

1. An variable optical attenuator comprising:
a first optical component for emitting a light beam;
a first lens for passing the light beam from said first optical component while diffusing the light beam;
a second lens for condensing a part of the diffused light from said lenses,
a second optical component for transmitting the condensed light beam from said second lens; and
control means for controlling an optical path length between said first and second lenses.

2. The attenuator according to claim 1, wherein
said control means includes a reflector having a first reflective surface and a second reflective surface, the deflector defining
a first optical axis portion extending between the first reflective surface and said first lens, a second optical axis portion extending between the second reflective surface and said second lens, the first and second optical axis portions, being parallel to each other and a third optical axis portion extending between the first reflective surface and the second reflective surface so as to connect the first and second optical axis portions, and
displacement means for displacing the deflector, said displacement means for varying lengths of the first optical axis portion and the second optical axis portion.

3. The attenuator according to claim 2, wherein
The first reflective surface and the second reflective surface are orthogonal to each other.

4. The attenuator according to claim 3, wherein
said displacement means includes at least one actuator employing an electrostatic force.

5. The attenuator according to claim 4, wherein
each of said first and second optical components is an optical fiber.

6. The attenuator according to claim 4, wherein
said first and second lenses are rod lenses, each of the lenses being connected to the first and second optical component, respectively.

7. The attenuator according to claim 6, wherein
said rod lens includes a grated index fiber.
